(19) United States
(12) Patent Application Publication
(10) Pub. No.: US 2020/0094471 A1
(43) Pub. Date: Mar. 26, 2020

(54) ADDITIVELY-MANUFACTURED COMPONENT HAVING AT LEAST ONE STIFFENING MEMBER AND METHOD OF FORMING THE SAME

(71) Applicant: THE BOEING COMPANY, Chicago, IL (US)

(72) Inventor: Andrew S. Niederschulte, Evanston, IL (US)

(73) Assignee: THE BOEING COMPANY, CHICAGO, IL (US)

(21) Appl. No.: 16/139,320

(22) Filed: Sep. 24, 2018

(51) Int. Cl. B29C 64/135; B29C 64/268; B22F 3/105; B29C 64/393

(52) U.S. Cl. CPC B29C 64/135; B29C 64/268; B33Y 80/00; B29C 64/393; B22F 3/1055

(57) ABSTRACT

An additively-manufactured component includes a main body, and at least one stiffening member. Each of the main body and the stiffening member(s) is additively manufactured layer-by-layer in a common build direction. A method of forming an additively-manufactured component includes forming a main body and at least one stiffening member of the additively-manufactured component layer-by-layer in a common build direction.

### FIELD OF THE DISCLOSURE

Embodiments of the present disclosure generally relate to additive-manufacturing systems and methods, and more particularly, to systems and methods of additively-manufacturing components having at least one stiffening member.

### BACKGROUND OF THE DISCLOSURE

Additive manufacturing systems and methods are used to fabricate components (such as parts or products) through multiple layers of material. For example, known additive manufacturing systems and methods form a component by adding layer-upon-layer of material. Additive manufacturing systems and methods may include or otherwise use three dimensional (3D) modeling (for example, computer-aided design or CAD) software, computer-controlled additive-manufacturing equipment, and raw materials in powder or liquid form.

Additive manufacturing encompasses a wide variety of technologies and incorporates a wide variety of techniques, such as, for example, laser freeform manufacturing (LFM), laser deposition (LD), direct metal deposition (DMD), laser metal deposition, laser additive manufacturing, laser engineered net shaping (LENS), stereolithography (SLA), selective laser sintering (SLS), fused deposition modeling (FDM), multi jet modeling (MJM), 3D printing, rapid prototyping, direct digital manufacturing, layered manufacturing, and additive fabrication. Moreover, a variety of raw materials may be used in additive manufacturing to create products. Examples of such materials include plastics, metals, concrete, and glass.

One example of an additive-manufacturing system is a laser additive-manufacturing system. Laser additive manufacturing includes spraying or otherwise injecting a powder or a liquid into a focused beam of a high-power laser or nexus of a plurality of high-powered lasers under controlled atmospheric conditions, thereby creating a weld pool. The resulting deposits may then be used to build or repair articles for a wide variety of applications. The powder injected into the high-power laser beam may include a wide variety of materials such as metal, plastic, and/or the like.

Many structural panels (particularly with respect to aerospace applications) include an orthogrid or isogrid support structure. Such supports typically include a first set of parallel ribs and a second set of parallel ribs that are orthogonal to the first set of parallel ribs. That is, the first set of parallel ribs are typically perpendicular to the second set of parallel ribs.

However, additively manufactured panels having orthogrid or isogrid support structures are typically formed through labor intensive, time intensive, and costly processes. For example, orthogonal ribs perpendicular to a build direction typically have to be supported during the manufacturing process with additional support material. The additional support material may be costly, both in terms of material cost and additional build time. Further, after the build is completed, the excess material has to be machined away to refine the part into final form. Again, such additional steps may be costly and may take time.

### SUMMARY OF THE DISCLOSURE

A need exists for a system and method of efficiently forming a structural component through an additive manufacturing process. Further, a need exists for an additively-manufactured component having at least one stiffening member that is efficiently formed.

With those needs in mind, certain embodiments of the present disclosure provide an additively-manufactured component that includes a main body, and at least one stiffening member. Each of the main body and the at least one stiffening member is additively manufactured layer-by-layer in a common build direction. The main body and the at least one stiffening member may be devoid of isogrid or orthogrid supports.

In at least one embodiment, an additive manufacturing head is configured to emit energy into a powder bed to form layers of the main body and the at least one stiffening member in the common build direction. In at least one embodiment, the main body and the at least one stiffening member form an offtake for an engine. The main body and the least one stiffening member may be formed of Titanium.

The additively-manufactured component may also include at least one longitudinal rib that extends along at least a portion of a length of the main body. The additively-manufactured component may be devoid of orthogonal ribs that orthogonally couple to the at least one longitudinal rib. A depth of the at least one stiffening member is greater than a depth of the at least one longitudinal rib.

In at least one embodiment, the at least one stiffening member includes a flattened protuberance that upwardly extends from the main body. The at least one stiffening member may include a first stiffening member and a second stiffening member. The first stiffening member may be sized and shaped differently than the second stiffening member. The first stiffening member may be at or proximate to an end, and the second stiffening member may be between the end and a distal tip.

In at least one embodiment, a depth of the at least one stiffening member is greater than a height of the at least one stiffening member.

Certain embodiments of the present disclosure provide a method of forming an additively-manufactured component. The method includes forming a main body and at least one stiffening member of the additively-manufactured component layer-by-layer in a common build direction. The forming may include emitting energy from an additive manufacturing head into a powder bed to form layers of the main body and the at least one stiffening in the common build direction.

### BRIEF DESCRIPTION OF THE DRAWINGS

FIG. 1 illustrates a schematic diagram of an additive manufacturing system, according to an embodiment of the present disclosure.

FIG. 2 illustrates a perspective top view of an additively-manufactured component, according to an embodiment of the present disclosure.

FIG. 3 illustrates a top view of the additively-manufactured component.

FIG. 4 illustrates a perspective internal view of a portion of a barrel having the additively-manufactured component secured thereto, according to an embodiment of the present disclosure.

FIG. 5 illustrates a flow chart of a method of forming an additively-manufactured component, according to an embodiment of the present disclosure.

### DETAILED DESCRIPTION OF THE DISCLOSURE

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular condition may include additional elements not having that condition.

Certain embodiments of the present disclosure provide an additively-manufactured component having at least one stiffening member. The stiffening member is formed via an additive manufacturing process, layer-by-layer, in the direction of build, as opposed to perpendicular to the direction of build. The additively-manufactured component may be devoid of isogrid or orthogrid supports. The stiffening member may be a flattened protuberance, such as a support panel.

The stiffening member(s) provide stiffness to the additively-manufactured component. The stiffening member(s) are vertically formed, layer-by-layer. Accordingly, the additively-manufactured component may be formed without isogrid or orthogrid supports, exhibit a desired stiffness (via the stiffening member(s)), and may be efficiently and cost-effectively formed.

Certain embodiments of the present disclosure provide a method of supporting a component (such as a complex thin membrane) that attaches to a pressurized vessel (such as a housing of an engine of an aircraft). In at least one embodiment, the component may be an offtake that is to be positioned within a housing of an engine.

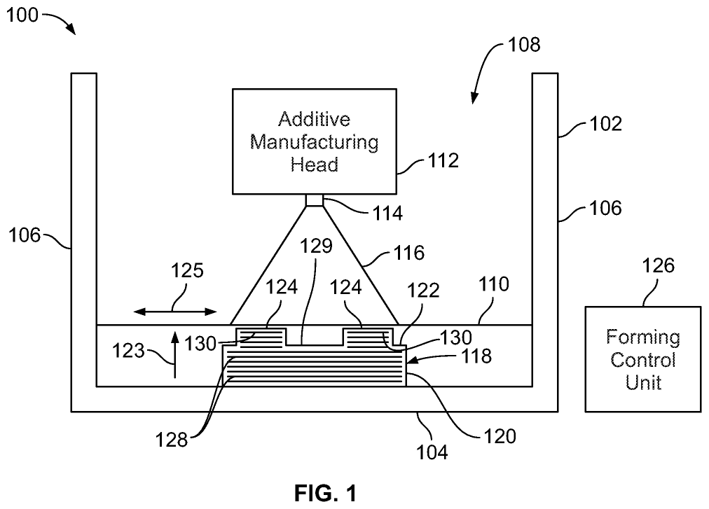

FIG. 1 illustrates a schematic diagram of an additive manufacturing system 100, according to an embodiment of the present disclosure. The additive manufacturing system 100 includes a container 102 that includes a base 104 and walls 106 upstanding from the base 104. The base 104 and the walls 106 define a forming chamber 108. The forming chamber 108 retains a powder bed 110, such as formed of metal, polymer, or other such material.

An additive manufacturing head 112 is fixed in position or moveable in relation to the forming chamber 108. The additive manufacturing head 112 includes an energy emitter 114 that emits energy 116 into the powder bed 110 to form a component 118, layer-by-layer, from a base surface 120 towards an upper surface 122 in a build direction 123. As shown, the build direction 123 may be a vertical direction that extends upwardly from the base 104 within the forming chamber 108. In at least one embodiment, the additive manufacturing head 112 is a laser scanner that emits the energy 116 as one or more laser beams through the energy emitter 114, which may be a laser output, array, and/or the like. Optionally, the additive manufacturing head 112 may be an electron beam scanner that emits one or more electron beams through the energy emitter 114, which may be an electron beam output, array, and/or the like. As another example, the additive manufacturing head 112 may be an arcing scanner that emits electrical arcing energy through the energy emitter 114, which may be an arcing output, array, and/or the like. U.S. Pat. No. 9,751,260, entitled “Additive Manufacturing Systems, Apparatuses, and Methods” discloses examples of an additive manufacturing head.

The additive manufacturing head 112 is configured to emit energy, such as one or more laser beams, into the powder bed 110 to form layers of the component 118 from the base surface 120 upwardly towards the upper surface 122 in the build direction 123. For example, the additive manufacturing head 112 may be configured to selectively laser sinter layers of material of the powder bed 110 onto an existing lower layer of material to form the component 118.

The additive manufacturing head 112 also forms one or more stiffening members 124 on or within a main body 129 of the component 118 in the build direction 123. The stiffening members 124 are integrally formed with the main body 129 of the component 118. The stiffening member(s) 124 are formed layer-by-layer in the build direction 123. The component 118 may be devoid of ribs that are orthogonal to the build direction 123 and/or the stiffening members 124. For example, the component 118 may be devoid of ribs that span across the component 118 and orthogonally intersect or otherwise connect to the stiffening members 124. The stiffening members 124 are formed layer-by-layer through an additively manufactured process (such as via the additive manufacturing head 112 emitting the energy 116 into the powder bed 110) in the build direction 123, in contrast to a direction 125 that is perpendicular to the build direction 123.

In at least one embodiment, the additive manufacturing system 100 includes a forming control unit 126, which may be configured to control (for example, operate) the additive manufacturing system 100. The forming control unit 126 may be in communication with the additive manufacturing head 112, such as through one or more wired or wireless connections. The forming control unit 126 may be configured to operate the additive manufacturing system 100 through preprogrammed instructions stored in memory.

In operation, the additive manufacturing head 112 emits the energy 116 (such as one or more laser beams) into the powder bed 110 to form layers 128 of the component 118, thereby forming the component 118 from the base surface 120 to the upper surface 122 in a layer-by-layer manner in the build direction 123. For example, the additive manufacturing head 112 selectively laser sinters the layers 128 from material within the powder bed 110 onto previously-formed existing layers 128. The stiffening members 124 of the component 118 are formed in the same manner. That is, layers 130 of the stiffening members 124 are additively-manufactured in the build direction 123 via the additive manufacturing head 112 emitting the energy 116 into the powder bed 110. The forming control unit 126 may control the additive manufacturing head 112 during the forming process.

The stiffening members 124 are integrally formed with the additively-manufactured component 118 through the additive manufacturing system 100 and additive manufacturing process. That is, the stiffening members 124 are integrally formed with the main body 129 of the additively-manufactured component 118. The stiffening members 124 are not grids, ribs, inserts, or the like over which another material is molded or coupled.

The additively-manufactured component 118 includes the main body 129 and the stiffening member(s) 124. Each of the main body 129 and the stiffening member(s) 124 is additively manufactured layer-by-layer in the common build direction 123.

In at least one embodiment, the component 118 may be formed through a freeform method, which may not include a powder bed. Instead, the powder may be blown directly onto the energy emitted from the additive manufacturing head to form the component 118.

As used herein, the term “control unit,” “central processing unit,” “unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the forming control unit 126 may be or include one or more processors that are configured to control operation of the additive manufacturing system 100, as described herein.

The forming control unit 126 is configured to execute a set of instructions that are stored in one or more data storage units or elements (such as one or more memories), in order to process data. For example, the forming control unit 126 may include or be coupled to one or more memories. The data storage units may also store data or other information as desired or needed. The data storage units may be in the form of an information source or a physical memory element within a processing machine.

The set of instructions may include various commands that instruct the forming control unit 126 as a processing machine to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of embodiments herein may illustrate one or more control or processing units, such as the forming control unit 126. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the forming control unit 126 may represent processing circuitry such as one or more of a field programmable gate array (FPGA), application specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

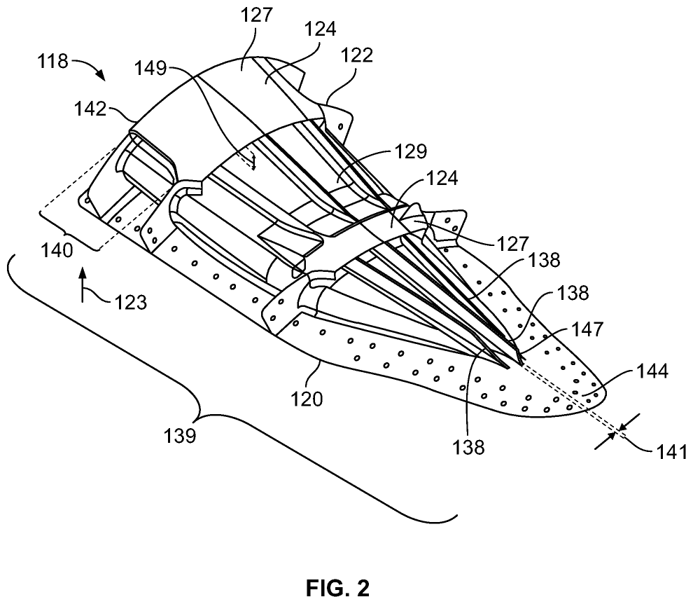

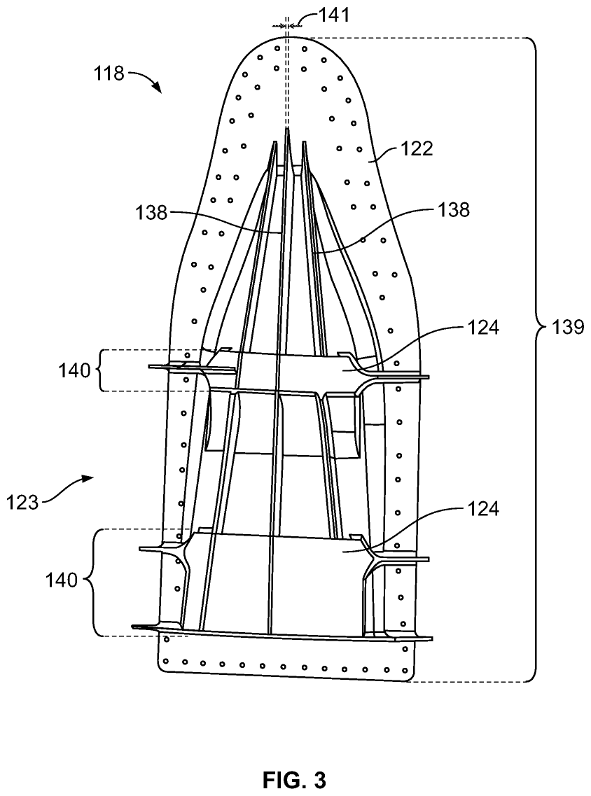

FIG. 2 illustrates a perspective top view of an additively-manufactured component 118, according to an embodiment of the present disclosure. FIG. 3 illustrates a top view of the additively-manufactured component 118. Referring to FIGS. 2 and 3, the additively-manufactured component 118 may be an offtake for an engine of an aircraft. The additively-manufactured component 118 may be formed of a metal, such as Titanium. The additively-manufactured component 118 is formed by an additive manufacturing system, such as the additive manufacturing system 100 shown and described with respect to FIG. 1.

The additively-manufactured component 118 includes the base surface 120 connected to the top surface 122 through a plurality of layers that are formed by the additive manufacturing system. The additively-manufactured component 118 includes stiffening members 124.

As shown, the additively-manufactured component 118 may include a plurality of longitudinal ribs 138. The ribs 138 extend along at least a portion of the length 139 of the additively-manufactured component 118. The additively-manufactured component 118 may be devoid of ribs that are orthogonal to the ribs 138. In at least one embodiment, the additively-manufactured component 118 may include more or less longitudinal ribs 138 than shown. In at least one embodiment, the additively-manufactured component 118 may not include any longitudinal ribs 138.

The stiffening members 124 may be flattened protuberances 127 that upwardly extend from a main body 129 of the additively-manufactured component 118. For example, the flattened protuberances 127 may be panels, straps, collars, sheaths, or the like. The stiffening members 124 provide rigidity and stiffness to the additively-manufactured component 118 without the need for orthogonal latitudinal ribs that are perpendicularly oriented in relation to the longitudinal ribs 138.

As shown, the depths 140 of the stiffening members 124 are substantially greater than the depths 141 of the longitudinal ribs 138. For example, the depths 140 of the stiffening members 124 may be five times, ten times, or even more the depths 141 of the longitudinal ribs 138.

As shown, the additively-manufactured component 118 may include first and second stiffening members 124. The stiffening members 124 may be sized and shaped differently. In at least one other embodiment, the stiffening members 124 may be sized and shaped the same. One of the stiffening members 124 may be at and/or proximate an end 142 of the additively-manufactured component 118, and the other stiffening member 124 may be between the end 142 and a distal tip 144 of the additively-manufactured component 118. Optionally, the stiffening members 124 may be positioned at different areas of the additively-manufactured component 118.

The additively-manufactured component 118 may have more or less stiffening members 124 than shown. For example, the additively-manufactured component 118 may be one stiffening member 124. Optionally, the additively-manufactured component 118 may have three or more stiffening members 124. As described above, the additively-manufactured component 118 including the stiffening member(s) 124 is formed layer-by-layer in the build direction 123. In at least one embodiment, the additively-manufactured component 118 is devoid of latitudinal ribs, such as which would otherwise orthogonally intersect or otherwise connect to at least one of the longitudinal ribs 138.

As shown, heights 147 of the ribs 138 are substantially greater than the depths 141 of the ribs 138. For example, the heights 147 may be five to ten times the depths 141. In contrast, the heights 149 of the stiffening members 124 are substantially less than the depths 140 of the stiffening members 124. For example, the depths 140 may be five to ten times greater than the heights 149. In short, the heights 147 of the ribs 138 are greater than the depths 141 of the ribs 138, while the depths 140 of the stiffening members 124 are greater than the heights 149 of the stiffening members 124.

The stiffening members 124 provide sufficient rigidity and stiffness to the additively-manufactured component 118 without the need for latitudinal ribs (or even the longitudinal ribs 138). Because the stiffening members 124 are formed through the additively-manufactured system 100 and process in the build direction 123, there is no need to reposition the additively-manufactured component 118 during the build process. Further, there is no need to provide numerous support structures to form numerous ribs. Moreover, there is no need for extensive post-processing steps to machine overhanging portions of isogrid or orthogrid supports. As such, the additively-manufactured component 118 provides sufficient rigidity and stiffness (via the stiffening member(s) 124) and is formed through an efficient and cost-effective additive manufacturing process.

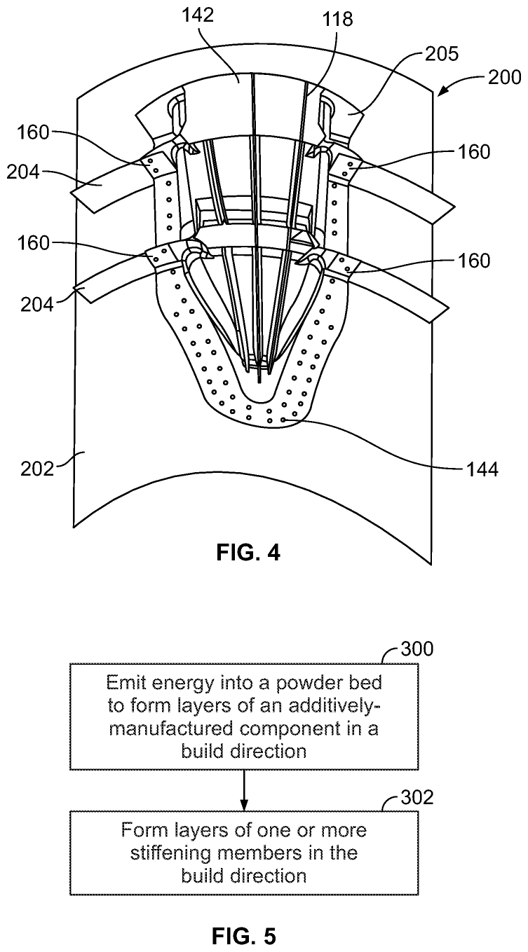

FIG. 4 illustrates a perspective internal view of a portion of a barrel 200 having the additively-manufactured component 118 secured thereto, according to an embodiment of the present disclosure. As indicated, the additively-manufactured component 118 may be an offtake, and the barrel 200 may form a portion of a housing of an engine of an aircraft.

The barrel 200 may include a composite outer skin 202, and arcuate inner metal (such as Aluminum) skin clips 204. The additively-manufactured component 118 may include an aft upstanding flange 205 that is configured to contact another structure (not shown). Fasteners may be used to secure the additively-manufactured component 118 to the skin clips 204 at bearing surfaces 160. The distal tip 144 is tapered in relation to the end 142 to provide an aerodynamic shape that is configured to channel air therethrough. In at least one embodiment, the barrel 200 includes mirrored portions, such that opposed, mirrored additively-manufactured components 118 are secured therein.

FIG. 5 illustrates a flow chart of a method of forming an additively-manufactured component, according to an embodiment of the present disclosure. Referring to FIGS. 1 and 5, at 300, the forming control unit 126 operates the additive manufacturing head 112 to emit the energy 116 into the powder bed 110 to form the layers 128 of the additively-manufactured component 118 in the build direction 123. At 302, the forming control unit 126 operates the additive manufacturing head 112 to form layers of one or more stiffening members 124 (such as on or within a main body) in the build direction 123.

In a least one embodiment, a method of forming an additively-manufactured component 118 includes forming the main body 129 and the stiffening member(s) 124 of the additively-manufactured component 118 layer-by-layer in the common build direction 123. The forming may include emitting energy 116 from the additive manufacturing head 112 into the powder bed 110 to form layers 128 and 130 of the main body 129 and the stiffening member(s) 124 in the common build direction 123.

The method may also include forming at least one longitudinal rib 138 that extends along at least a portion of a length 139 of the main body 129. The forming the main body 129 and the stiffening member 124 may include forming the stiffening member(s) 124 with a depth 140 that is greater than a depth 141 of the longitudinal rib(s) 138.

The forming the main body 129 and the stiffening member(s) 124 may include forming the stiffening member(s) 124 as a flattened protuberance that upwardly extends from the main body 129. The forming the main body 129 and the stiffening member(s) 124 may include forming a first stiffening member 124 and a second stiffening member 124.

In at least one embodiment, the forming the main body 129 and the stiffening member(s) 124 includes forming the stiffening member(s) 124 to have a depth 140 is greater than a height 149.

Referring to FIGS. 1-5, in at least one embodiment, the main body and the stiffening members may be formed simultaneously. Further, in at least one embodiment, the component may be formed through a freeform method, which may not include a powder bed. Instead, the powder may be blown directly onto the energy emitted from the additive manufacturing head to form the component.

As described herein, embodiments of the present disclosure provide systems and methods of efficiently forming components having support structures through an additive manufacturing process. Further, embodiments of the present disclosure provide additively-manufactured components having at least one stiffening member that is efficiently formed.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. An additively-manufactured component comprising:
a main body; and
at least one stiffening member, wherein each of the main body and the at least one stiffening member is additively manufactured layer-by-layer in a common build direction.

2. The additively-manufactured component of claim 1, wherein the main body and the at least one stiffening member are devoid of isogrid or orthogrid supports.

3. The additively-manufactured component of claim 1, wherein an additive manufacturing head is configured to emit energy into a powder bed to form layers of the main body and the at least one stiffening member in the common build direction.

4. The additively-manufactured component of claim 1, wherein the main body and the at least one stiffening member form an offtake for an engine.

5. The additively-manufactured component of claim 1, wherein the main body and the least one stiffening member are formed of Titanium.

6. The additively-manufactured component of claim 1, further comprising at least one longitudinal rib that extends along at least a portion of a length of the main body.

7. The additively-manufactured component of claim 6, devoid of orthogonal ribs that orthogonally couple to the at least one longitudinal rib.

8. The additively-manufactured component of claim 6, wherein a depth of the at least one stiffening member is greater than a depth of the at least one longitudinal rib.

9. The additively-manufactured component of claim 1, wherein the at least one stiffening member comprises a flattened protuberance that upwardly extends from the main body.

10. The additively-manufactured component of claim 1, wherein the at least one stiffening member comprises a first stiffening member and a second stiffening member.

11. The additively-manufactured component of claim 10, wherein the first stiffening member is sized and shaped differently than the second stiffening member.

12. The additively-manufactured component of claim 10, wherein the first stiffening member is at or proximate to an end, and wherein the second stiffening member is between the end and a distal tip.

13. The additively-manufactured component of claim 1, wherein a depth of the at least one stiffening member is greater than a height of the at least one stiffening member.

14. A method of forming an additively-manufactured component, the method comprising:
forming a main body and at least one stiffening member of the additively-manufactured component layer-by-layer in a common build direction.

15. The method of claim 14, wherein the forming comprises emitting energy from an additive manufacturing head into a powder bed to form layers of the main body and the at least one stiffening in the common build direction.

16. The method of claim 14, further comprising forming at least one longitudinal rib that extends along at least a portion of a length of the main body.

17. The method of claim 16, wherein the forming the main body and the at least one stiffening member comprises forming the at least one stiffening member with a depth that is greater than a depth of the at least one longitudinal rib.

18. The method of claim 14, wherein the forming the main body and the at least one stiffening member comprises forming the at least one stiffening member as a flattened protuberance that upwardly extends from the main body.

19. The method of claim 14, wherein the forming the main body and the at least one stiffening member comprises forming a first stiffening member and a second stiffening member, wherein the first stiffening member is sized and shaped differently than the second stiffening member, wherein the first stiffening member is at or proximate to an end, and wherein the second stiffening member is between the end and a distal tip.

20. The method of claim 14, wherein the forming the main body and the at least one stiffening member comprises forming the at least one stiffening member to have a depth is greater than a height.
